(19) United States
(12) Patent Application Publication
(10) Pub. No.: US 2004/0268407 A1
(43) Pub. Date: Dec. 30, 2004

(54) Centralized resource manager

(76) Inventors: Carlton J Sparrell, Marblehead, MA (US); Alexander Vasilevsky, Westford, MA (US); John A. Watlington, Acton, MA (US); David F. Lively, Hudson, MA (US)

Correspondence Address: Covington & Burling, 1201 Pennsylvania Avenue N W, Washingtom, DC, 20004-2401, US

(21) Appl. No.: 10/490,225

(22) PCT Filed: Sep. 6, 2002
(86) PCT No.: PCT/US02/28353

Related U.S. Application Data
(60) Provisional application No. 60/323,618, filed on Sep. 20, 2001.
(60) Provisional application No. 60/350,431, filed on Jan. 19, 2002.
(60) Provisional application No. 60/372,490, filed on Apr. 12, 2002.

(51) Int. Cl. H04N 7/173; H04N 7/16

(52) U.S. Cl. 725/116; 725/146; 725/117; 725/147; 725/93

(57) ABSTRACT

A centralized resource manager for distributed networks manages resources available on the network, such as network bandwidth, CPU allocation, TV tuners, MPEG encoders and decoders, disk bandwidth, and input/output devices. The centralized resource manager also allocates the resources of network clients and a network-associated media server, in response to requests for media services via the distributed network. The centralized resource manager may include means for discovering when devices are added or removed from the network; a current, IR, or electromagnetic field sensing system for determining when video devices are turned off so that resources associated with any device not in use may be reallocated elsewhere; or a power switching system for controlling the ON or OFF state of such devices so that resources associated with any device in the OFF state may be reallocated elsewhere.

### PRIORITY CLAIM

The present patent application claims priority of the following co-pending, commonly owned patent applications:

60/323,618 filed Sep. 20, 2001 (Atty. Dkt. UCN-016);

60/350,431 filed Jan. 19, 2002 (Atty. Dkt. UCN-019); and

60/372,490 filed Apr. 12, 2002 (Atty. Dkt. UCN-032).

### INCORPORATION BY REFERENCE

The present application for U.S. patent claims the benefit of and incorporates herein by reference the contents of the following commonly owned U.S. patent applications:

Ser. No. 09/365,726 filed Aug. 3, 1999, entitled “Multi-Service In-Home Network With an Open Interface”;

Ser. No. 09/809,770 (Atty. Dkt. UCN-006) filed Mar. 16, 2001, entitled “Home Area Network Including Arrangement for Distributing Television Programming Over Local Cable”;

60/193,813, filed Mar. 31, 2000, entitled “Home Area Network”;

60/313,209 (Atty. Dkt. UCN-011), filed Aug. 17, 2001, entitled “Delivering Multimedia Over Home Area Networks”;

60/313,228, filed Aug. 17, 2001, entitled “Web Services Provisioning Architecture”;

60/327,627 (Atty. Dkt. UCN-012), filed Oct. 5, 2001, entitled “Home Area Network Centralized Video Recorder”;

60/345,966 (Atty. Dkt. UCN-017), filed Nov. 7, 2001, entitled “Digital Video Recording System Supporting Concurrent Playback Using Advanced Program Information”;

Ser. No. 10/017,675 (Atty. Dkt. UCN-018) filed Dec. 15, 2001, entitled “Centralized Digital Video Recording and Playback System Accessible To Multiple Reproduction And Control Units Via A Home Area Network”;

Ser. No. 10/032,218 (Atty. Dkt. UCN-015) filed Dec. 21, 2001, entitled “Digital Video Recording and Reproduction System And Method Suitable For Live-Pause Playback Utilizing Intelligent Buffer Memory Allocation”;

60/323,618 (Atty. Dkt. UCN-016) filed Sep. 20, 2001, entitled “Home Network Platform, Architecture and System”;

60/350,431 (Atty. Dkt. UCN-019) filed Jan. 18, 2002, entitled “Home Area Network Traffic Management with a Networked Personal Video Recorder”;

60/350,431 (Atty. Dkt. UCN-032) filed Apr. 11, 2002, entitled “Centralized Resource Manager.

### FIELD OF THE INVENTION

The present invention relates generally to home networks having multiple digital content storage, access and/or display elements, and in particular, relates to a centralized resource manager that utilizes a passive sensing mechanism to control, allocate and otherwise manage distributed network resources in such home networks.

### BACKGROUND OF THE INVENTION

The concept of linking multiple digital entertainment devices in a home network infrastructure has become widely accepted. It is now possible to interconnect a plurality of these devices—including televisions and video recording devices, audio recording and playback devices, personal computers, and telephony devices—in a network having sufficient bandwidth to distribute media content (e.g., movies, audio/stereo) and data throughout a home, as desired by the individual users, so that the resources of the devices may be shared. However, the sharing of these multiple devices in a home-based network presents new problems in allocating and managing the resources of the various devices in an efficient manner.

Members of the Home Audio Video Interactive (HAVi) alliance have developed a protocol for dealing with distributed devices across a bus architecture (typically IEEE 1394 or FireWire), using concepts of resource management and reservation. Under the HAVi protocol, certain devices will allow partial or total reservation of their resources. These devices include their own local resource manager component. A device wishing to reserve resources will communicate with the local resource manager associated with that device. If another device has reserved these resources, the device requesting these resources may negotiate with the resource holder by communicating messages through the local resource manager of the device in question.

However, the HAVi methodology is limited in several ways. First, the device wishing to establish a complete media pipeline/session is responsible for establishing the reservations with each of the components. This is inefficient, and can possibly result in deadlock timing situations from competing reservation requests. Second, only devices on the network providing local resource managers may be reserved. There is no proxy device for reserving the resources of “dumb” devices (i.e., devices having no local resource manager associated therewith) on the network. Third, the distributed nature results in added complexity for each device that must support a local resource manager.

UPnP and Jini are similar resource discovery and control tools. Both of these lack any robust resource management tools. They are also implemented in a manner similar to HAVi, in that all devices are responsible for supporting the protocol, and support distributed, not centralized, interaction.

In addition, Tivo, ReplayTV, and others have developed personal video recording (PVR) products, which allow a user to digitally store television programs and other media content for later viewing. Each of these products supports the reservation of a tuner to support a scheduled recording of television shows. However, neither supports distributed networks or distributed resource management.

Accordingly, there exists a need for devices and systems that support distributed networks and centralized management of distributed network resources.

### SUMMARY OF THE INVENTION

The present invention overcomes the disadvantages of prior art systems, by providing a centralized resource manager, rather than relying on a plurality of local resource managers. The invention requires only one device to act as a centralized resource manager, enables the centralized resource manager to assign network resources in the most efficient manner, and provides proxy reservations where necessary for devices on the distributed network that do not include a local resource manager.

The centralized resource manager of the invention can be linked with a media server and each client device in the distributed network. The centralized resource manager identifies, assigns, and reserves available network resources in response to user requests for processing media content so that the functionality of the distributed network is centralized, in a manner which most efficiently uses the resources of the distributed network. Managed resources can include, among others, network bandwidth, CPU allocation, TV tuners, MPEG encoders and decoders, disk bandwidth, applications, and input/output devices.

In a home-networking environment, a centralized resource manager allocates network resources in the following manner. In one embodiment, requests are made to the centralized resource manager by agent processes in response to requests received from a user for viewing or recording television programming material, or from agent processes acting on behalf of the user, such as an agent process using user profile or history information to predict that a user that has watched, for example, several James Bond titles in the past would likely wish to record “Thunderball” and automatically schedule that recording on the user's behalf. When a request is received from a user or agent process for viewing or recording television programming material, which may include viewing or recording television programming material available at a scheduled future time and channel, the centralized resource manager implements a reservation protocol (e.g., least-cost algorithm) to define a pipeline or session, using the available network resources embodied in the media server and client devices, to fulfill the user's request. The centralized resource manager identifies available network resources that match the requirements imposed by the user request using a scheduling algorithm to determine the availability of such network resources when the program will be viewed or recorded.

Once an audio-video pipeline has been defined from the available network resources, these network resources are assigned and reserved for the appropriate time, and a reservation identifier is returned to the scheduling application. The reservation is stored in a reservation table for use by the centralized resource manager in connection with any future user requests. The reservation identifier may include identification of the specific resources assigned, which would allow the requesting application to communicate with, configure, and control the assigned resources.

In another aspect of the invention, the audio-video pipeline can be constructed using a least cost algorithm to minimize the use of network bandwidth. In a further aspect of the present invention, in response to the user scheduling an event, the centralized resource manager checks to see if a disk storage device in the network has sufficient disk space to record the media program. If the disk space is insufficient, the centralized resource manager searches for any files that may be deleted. The user may be alerted by displaying a message on the television screen or alerted when there are insufficient network resources to process the user's current request.

In another aspect of the invention, the centralized resource manager can include an interface to a service provider that allows the service provider to reserve resources in response to the service provider scheduling an event. In a further aspect of the invention, the centralized resource manager communicates with a service provider Network Operation Center over a WAN interface when the service provider wishes to reserve resources for events such as pushing of special content or software upgrades.

The centralized resource manager can also include sensing systems that are operable to determine when devices are added or removed from the network. These means may include a current, infrared (IR), or electro-magnetic field (EMF) sensing systems for detecting when video devices are turned off so that the network resources associated with that video device may be reallocated. The IR sensing system is operative to detect and process signals from a typical IR remote control device, and thereby determine the on/off state of the corresponding video device, so that resources associated with that device can be automatically reallocated.

The centralized resource manager can also include a power switching system that is operable to control the on/off state of devices attached to the network. This system may include the ability to plug devices into a switched power supply allowing the centralized resource manager to determine the powering on and off of the devices such that network resources associated with these devices may be automatically reallocated when the devices are determined to be in an OFF state. A typical IR or radio-frequency (RF) remote control device can be used to allow the user to command turning on and off of any device equipped with a power switching system.

The present invention may be implemented in a single network that uses video clients, audio clients, PC, and other devices. Various networking protocols and architectures can be used, including wireless LANs.

### BRIEF DESCRIPTION OF THE DRAWINGS

These and other features and advantages of the present invention will become apparent to those skilled in the art from the description below, with reference to the following drawing figures, in which:

FIG. 1 generally illustrates a home network having a centralized resource manager (CRM) in accordance with the present invention.

FIG. 2 shows another example of a network using the CRM of the present invention.

FIG. 3 illustrates a basic audio-video pipeline configuration suitable for use with the present invention.

FIG. 4 illustrates another audio-video pipeline configuration.

FIG. 5 illustrates yet another audio-video pipeline configuration, utilizing LAN resources.

FIG. 6 illustrates still another audio-video pipeline configuration, utilizing the resources of two clients.

FIG. 7 shows a basic block diagram of a media server and a typical client as taught in the present invention.

FIG. 8 is a block diagram of another embodiment of a CRM according to the present invention.

FIG. 9 illustrates another aspect of the present invention which includes a current sensing system to detect the ON or OFF status of a television set.

FIG. 10 illustrates an example of circuitry used to implement the current sensing system of FIG. 9.

FIG. 11 shows an example using an IR sensing system to detect the ON or OFF status of a television set to automatically control resource allocation.

FIG. 12 shows further detail of the embodiment of FIG. 11.

FIG. 13 is a flowchart of one method for prioritizing resource allocation using IR signals from the IR sensing system.

FIG. 14 is a flowchart of an alternative method for prioritizing resource allocation using IR signals from the IR sensing system.

FIG. 15 illustrates another aspect of the present invention in which an electromagnetic field sensing system is used to detect the ON or OFF status of a television set.

FIG. 16 shows further detail of the embodiment of FIG. 15.

FIG. 17 shows further detail of the embodiment of FIG. 15.

FIG. 18 illustrates another aspect of the present invention in which a power switch is used to control the ON or OFF status of a television set to facilitate the automatic reallocation of resources.

### DETAILED DESCRIPTION OF PREFERRED EMBODIMENTS

Overview: The present invention is directed to a centralized resource manager (CRM) that can be linked to a plurality of networked devices in a distributed network. One such network could be a home network having digital entertainment, computing, and communication devices. Examples of network services include audio and video processing (e.g., recording audio and/or video content for storage or real-time use), distributing audio and/or video content for real-time presentation to a user (e.g., listening to a stereo system or viewing and listening via a television set), and data and graphics processing (e.g., creation, modification, display, storage, or rendering of data or graphics by using a PC or other devices or applications). Illustrative descriptions of distributed home networks are set forth below.

In accordance with known network practice, each of the devices or functional systems in the network can have resources that can be used by the functional system in conjunction with the services it provides. In the following discussion, network devices or functional systems are divided into two broad categories: client devices and atomic devices. A client device is any functional system that includes a local resource manager that provides a mechanism for control of resources useable by that client device. Such resources can be local resources, i.e., integral to the client device, and/or remote resources, e.g., resources non-integral to the client device but available thereto via a server. An atomic device is any functional system that does not include a local resource manager.

In accordance with the invention, while local resource managers exercise control over the set of resources useable by their respective client devices, the centralized resource manager controls not only these resources, but also the resources of atomic devices (i.e., proxy control) and the resources of the distributed network as a whole. Any conflict in the exercise of control over resources between the centralized resource manager and the respective local resource manager can be resolved in favor of the centralized resource manager.

In response to a user or agent process request to provide a service, e.g., a media processing service such as recording a movie distributed by an external provider, the centralized resource manager exercises master control over the network resources by identifying network resources that are available to fulfill the user (or agent process) request, assigning specific network resources from the available network resources to define a media pipeline or session that fulfills the user request, and reserving the network resources defining the media pipeline to fulfill the user (or agent process) request. The reserved network resources can be used immediately or scheduled for use at a future date. Once the reserved network resources have been used to fulfill the user or agent process request, the centralized resource manager frees these network resources, changing their status from “reserved” to “available”.

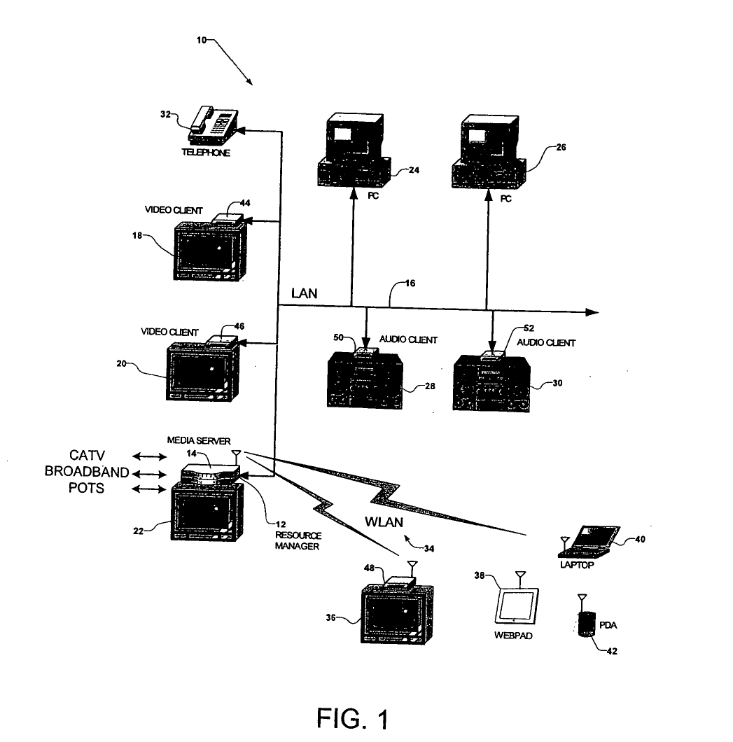

Exemplary Architectures: Referring to FIG. 1, a distributed network 10 is shown that embodies the present invention of a centralized resource manager 12, which is contained within a media server 14. This centralized resource manager 12 is used in a distributed home network 10, and more specifically, in connection with home networked personal video recording and media distribution equipment. The centralized resource manager 12 also supports other client and atomic devices and services, such as PCs, telephones, network attached storage, webpads, and PDAs, interlinked with the home-based distributed network 10. In FIG. 1, the distributed home network 10 includes a LAN 16, which interlinks televisions 18, 20, 22, personal computers 24, 26, audio recording and playback devices 28, 30 and a standard telephone 32. Utilizing a wireless local area network (WLAN) capability 34, the distributed home network 10 is also shown to support links to a remote television 36, a webpad 38, a laptop computer 40 and a PDA 42.

The centralized resource manager 12 of FIG. 1 is responsible for identifying, managing and reserving network resources for client and/or atomic devices comprising the distributed home network 10. The centralized resource manager 12 can exercise master control of current network resources, and can expand the network resources by the addition of client and/or atomic devices to the distributed home network 10. Representative examples of network resources for the distributed home network 10 depicted in FIG. 1 include network bandwidth, CPU allocation, disk bandwidth, TV tuners, MPEG encoders and I/O devices. Representative examples of various client devices include set-top boxes (STBs) 44, 46, 48 for video clients and STBs 50, 52 for audio clients. Other devices can similarly be employed.

Typically, the centralized resource manager 12 is located in a gateway device that manages the LAN and WAN links of the distributed home network 10, although one skilled in the art will understand that the foregoing description does not limit the present invention. In the embodiment shown in FIG. 1, the media server 14, which includes the centralized resource manager 12, is used for storing and serving audio, video and data content across the distributed home network 10.

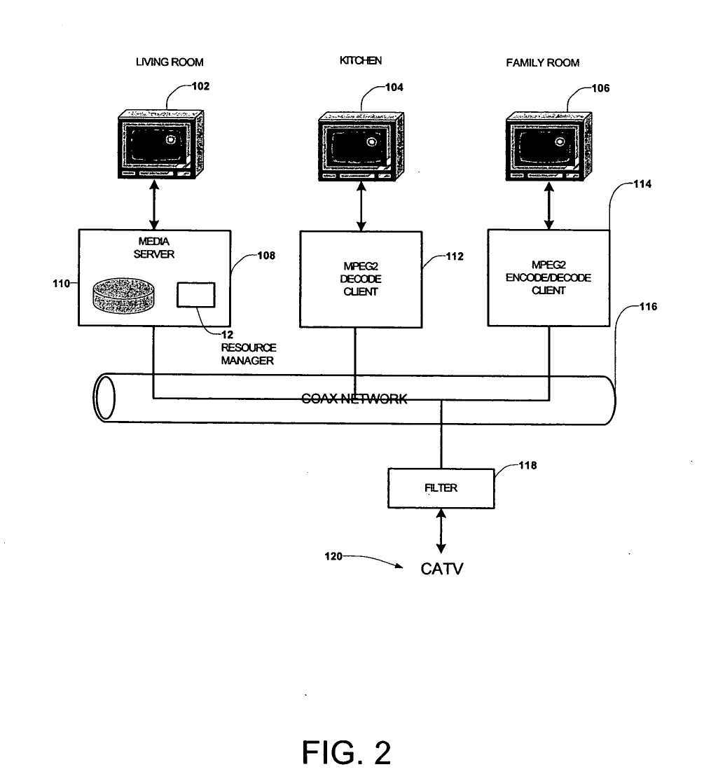

Another example of a distributed home network utilizing the centralized resource manager 12 is illustrated in FIG. 2. In particular, FIG. 2 illustrates a home-based distributed network that includes three televisions 102, 104, 106. One television 102 is connected to a media server 108. The media server 108 is capable of rendering graphics, decoding MPEG2, blending the content for display, tuning in CATV channels (analog or digital) and MPEG2 encoding audio-video streams, i.e., the media server 108 functions as a client device. The media server 108 also includes a disk storage device 110 capable of storing and retrieving MPEG2 files. A second TV 104 is connected to a video client device 112 capable of rendering graphics, decoding MPEG2 video and blending the content for display. A third television 106 is connected to a client device 114 capable of rendering graphics, decoding MPEG2 video, blending the content for display, tuning in one CATV channel 120 (analog or digital) and MPEG2 encoding of analog content.

The distributed network 116 comprises a typical 75-ohm coaxial cable used to deliver analog and digital cable channels through splitters to televisions, VCRs, etc. A LAN functionality is superimposed over the coax using frequency division multiplexing (e.g., using frequencies above or below the CATV channels for a general purpose data link). In this example, this network is Ethernet-over-coax, but other solutions exist, such as IEEE 1394 over coax, or HPNA over coax. In some topologies, a filter 118 may be required to prevent the data network frequencies from reaching outside the home.

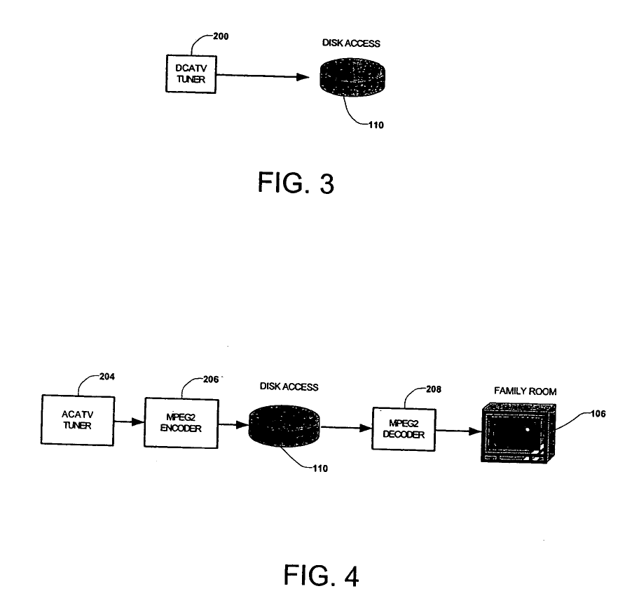

Examples of Operation: A method of controlling audio-video network resources of a distributed network by means of a centralized resource manager will now be described. Consider an evening of family television viewing. Earlier in the day, Dad programmed a client device to record the hockey game (media content) at 8:00 PM on channel 150 (the user request). Dad used a graphical user interface (GUI) to navigate to the Electronic Program Guide (EPG) application of the client device and selected the game to record. The centralized resource manager includes a scheduling application that requests a reservation of an audio-video pipeline or session with the resource requirements shown in FIG. 3, i.e., as defined by the user request.

Referring now to FIG. 3, which shows a DCATV Tuner 200 and a disk storage medium 110, the resource requirements can be described in the following manner. Since the hockey game is on a digital channel, the request is made for a digital-capable tuner 200. Further requirements may be made on this tuner, such as it has an associated Conditional Access module enabling that tuner to tune to the appropriate channel. The reservation also requires access to the disk 110 to record the hockey game (such as by writing to a disk file). This requires two types of reservation: disk bandwidth and disk capacity.

The centralized resource manager 12 will search the resource database to identify available network resources that match the resource requirements imposed by the user request. In the system described, there is one disk 110 (and more specifically one partition for video reported to the centralized resource manager 12) and three tuners. In this example, all three tuners have the same capabilities, and are distinguished only by their location in the distributed network. The centralized resource manager 12 implements a resource protocol, e.g., a least-cost algorithm, for constructing the media session or pipeline, i.e., identify available network resources, assign available network resources to fulfill the request, and reserve the assigned network resources. Using one of the two tuners associated with the media server 108, the media pipeline can be constructed without using network bandwidth. By using the tuner in one of the client devices 112, 114, in contrast, the centralized resource manager 12 would need to reserve network bandwidth. There is no cost difference between the two local tuners associated with the media server 108, so the lower number one is chosen.

The centralized resource manager 12 checks the disk storage device 110 for disk space both when the user schedules the recording and shortly before the recording event. If insufficient disk space is available when the user schedules the event, the centralized resource manager 12 checks to see if the disk storage device 110 includes any “delete-able” files. If all the files on the disk storage device 110 are marked as “do not delete”, the user will be alerted that the user request cannot be fulfilled (scheduled) due to insufficient recording space on the disk storage device 110. If sufficient disk space is available (or there are deleteable files), disk space will be reserved at the time of the request by the centralized resource manager 12. However, disk space will not be created (by deleting files) until the time the recording is scheduled to begin.

The centralized resource manager 12 also reserves disk bandwidth for the recording at the time the recording is scheduled. Upon successful reservation of the required network resources, the reservation is stored in a network resource reservation table for use in comparison against future user (or agent process) requests. Reservation of network resources to fulfill any request, i.e., the media pipeline or session, is communicated back to the scheduling application with a reservation id for the specific event.

At 7:30, the children want to watch a show in the family room. This television 106 is associated with the client device 114 with the MPEG2 encoder 206. The show they want to watch is on analog channel. They select this program from the EPG and the scheduling application contacts the centralized resource manager 12 to request network resources. FIG. 4 illustrates the resulting situation.

As shown in FIG. 4, the end of the pipeline or session is the video display of television 106. More specifically, the requested media pipeline needs to terminate with the display on the family room set 106. The video compression/decompression functionality supported by the distributed network is MPEG2. The media pipeline needs to decode MPEG2 by means of an MPEG2 decoder 208 prior to video display. Live-pause functionality is requested, so a network resource requirement imposed by the user request includes elastic recording to the disk storage device 110. Prior to recording on the disk storage device 110, the video needs to be encoded with an MPEG2 encoder 206. The channel requested is available in the analog spectrum, so an analog tuner 204 is required.

Note that with the exception of the video output display provided by the television set 106, the requested pipeline is not limited by the location in the distributed network where the network resources are located. The centralized resource manager will use resource protocols, e.g., least cost-of-bandwidth algorithms, to determine which network resources are assigned to fulfill the user request.

Bandwidth requirements for un-encoded video are high, so the MPEG2 decoder 208 chosen is the decoder in the client device 114 (see FIG. 2) attached locally to the family room television 106. Similarly, the MPEG2 encoder 206 needs to be local to the analog tuner 204. There are two available tuners on the system; one in the media server 108 next to the living room television 102, and one in the family room in the client device 114. While the tuner in the family room is local to the set 106, the video content needs to be written to the disk storage device 110 in the media server 108. The least-cost algorithm leads the centralized resource manager 12 to assign the tuner/encoder pair in the media server 108 to the media pipeline, thereby eliminating the requirement to write encoded data twice across the distributed network. This method preserves more network bandwidth for other uses such as data transfers between PCs linked to the distributed network. It should be obvious to those skilled in the art that algorithms other than least-cost can be used to assign the network resources to fulfill a user (or agent process) request.

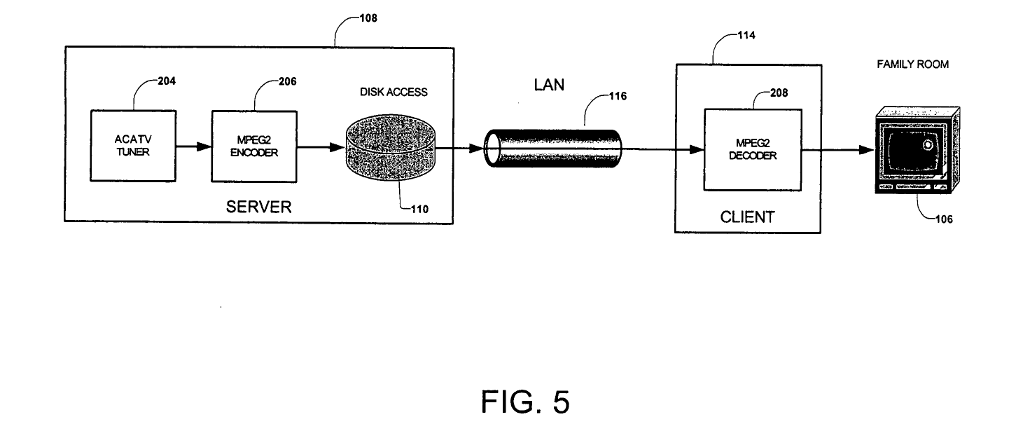

Once the centralized resource manager 12 has successfully mapped the requested media pipeline to available network resources, the instantiated graph is returned to the scheduling application, and the assigned resources are marked as reserved (indefinitely). The centralized resource manager 12 has assigned one other resource to the graph, as shown in FIG. 5. Referring now to FIG. 5, it will be understood that the LAN connection is required to connect the resources of the media server 108 to the resources of the client device 114. The LAN 116 is a managed network resource, and for this pipeline bandwidth is reserved for the video content.

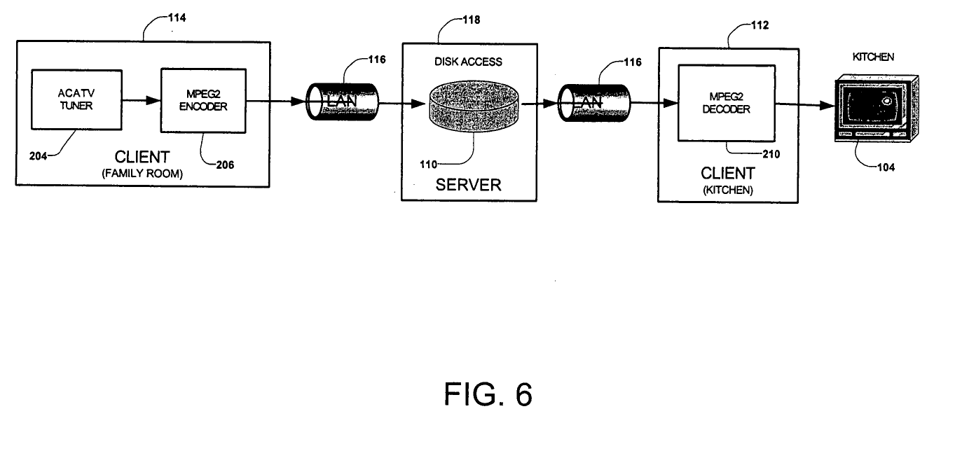

At 7:45, Mom wants to watch a program in the kitchen. The television 104 in the kitchen is connected to the decode-only video client device 112 (see FIG. 2). The centralized resource manager 12 asks for a second media pipeline or session identical to that described in connection with FIG. 4. In this case, however, the only tuner available in the distributed network is the tuner 204 in the client device 114 in the family room. The centralized resource manager 12 completes the media pipeline or session as shown in FIG. 6. In this example, two network resources 116 need to be added to the media pipeline, and twice the bandwidth reserved on the distributed network.

At 7:50, the distributed network prepares to record the hockey game. Most of the network resources have been reserved, but the centralized resource manager 12 needs to verify that disk space is available on the disk storage device 110. If there is not sufficient disk space to record the program, existing files will need to be deleted. If disk space cannot be made available (user has marked all existing files as “do not erase”), an exception will be generated and the recording will not take place. Typically, an alert is displayed on the television screens allowing the user to make room on the disk storage device 110.

At 8:00 the recording of the hockey game takes place.

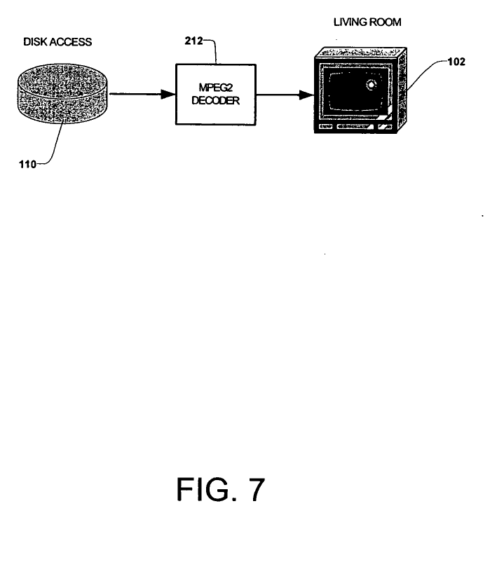

At 8:05, Dad sits down in the living room to watch a program on television 102. If a program is selected by the EPG, a request for network resources similar to that shown in FIG. 4 will be made of the centralized resource manager 12. In this case, there are no more tuners available in the distributed network. The centralized resource manager 12 will alert the user (Dad) of this information. Dad now has the option of watching one of the streams in progress, such as the hockey game, or watching a previously recorded show. Navigating the video library, Dad selects a James Bond movie recorded earlier that week. An updated request for resources, as shown in FIG. 7, is now requested via the centralized resource manager 12.

There is an MPEG2 decoder 212 available in the network resources, and provided disk bandwidth is available, the centralized resource manage 12 would assign and reserve these network resources as a media pipeline that would allow Dad to view the James Bond movie on television 102.

There is one more option that Dad could have chosen. He could have requested to “steal” a tuner from one of the other media pipelines, i.e., utilizing a network resource (tuner) that had previously been reserved by the centralized resource manager 12. While this approach probably would not endear Dad to others in this scenario, there are cases where such behavior may occur. For example, in the typical home-based distributed network, a centralized resource manager has no way of knowing when any particular TV is on or off. If Mom turns off the TV in the kitchen, without indicating this action to the centralized resource manager, the tuner associated with the kitchen TV is still allocated to the media pipeline she requested. Rather than force someone to go to the kitchen and free up the tuner, the GUI is configured to allow another user to appropriate network resources from another media pipeline. The scheduling application communicates with the centralized resource manager 12 to tear down the previously instantiated graph (media pipeline) and re-allocate the network resources to the current media request. One method of alleviating this is to allow the client device to be turned off or put in a standby mode. Other methods, including ways of indicating, to the centralized resource manager 12, which network resources can be freed up, are discussed below.

Each of the media pipelines described above can be torn down when they are no longer needed, e.g., when particular requests have been fulfilled. For example, the network resources for fulfilling a recording request, such as the tuner 200, can be freed up when the scheduled recording of the hockey game is completed.

Note that this example specifically illustrates the negotiation of network resources to build a media pipeline or session. Similarly, the centralized resource manager 12 allows reservation of network resources for audio (music) and graphics pipelines. Typically, a graphics pipeline is established at boot time or when a new client/atomic device is added to the distributed network. The graphics network resources are reserved and the graphics pipelines instantiated to allow applications running on the media server 108 and rendered on the client devices, or applications running on the client devices accessing data on the WAN or LAN 116 to reserve necessary network resources to provide the GUI and application services necessary to fulfill a particular user request.

Also note that this example specifically illustrates negotiation of a partial set of network resources to build a complete pipeline. The centralized resource manager 12 may not explicitly manage all segments of a pipeline. For example, a PCI bus connecting only an IDE hard-drive interface to an Ethernet network interface may provide far greater bandwidth than the network or hard-drive interfaces can support. In this case, reservation support of the PCI bus bandwidth may not be necessary in order to construct a resource pipeline. It should be apparent to those skilled in the art that the centralized resource manager described herein may be used to allow reservation of one or more of the resources necessary to build a network pipeline.

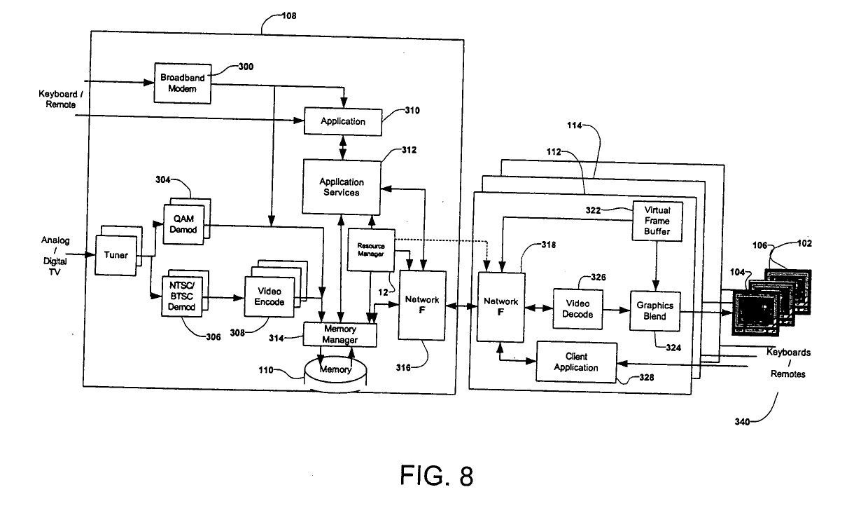

Media Server: FIG. 8 shows a block diagram of the media server 108 and client devices 112, 114 of one described embodiment of a distributed network according to the present invention. In some embodiments of the invention, the centralized resource manager 12 is contained in the media server 108. The media server 108 accepts CATV (both analog and digital) as well as broadband (cable modem, xDSL, etc.) WAN connectivity. In some embodiments, there is also a link to subscriber-to-subscriber POTS telephony service. The media server 108 is illustrated as the left half of FIG. 8. Digital cable typically enters the distributed network as a QAM modulated transport stream containing several MPEG2 program streams and is received by a tuner 302. The QAM content is demodulated, and the MPEG2 stream is de-multiplexed to provide the stream or streams of media content. A conditional access module may be required to decrypt the digital cable stream prior to the data being available for display or storage to disk storage device 110. The data may be re-encrypted prior to being written to persistent storage such as the disk storage device 110. Some conditional access methods allow data to be stored in the original encrypted format and decrypted just prior to display.

Analog CATV also enters the distributed network through the same interface, or through a secondary interface. In a cable system interface to the distributed network, both DCATV and ACATV typically share the same coax network using frequency division multiplexing. In satellite systems, all content provided to the distributed network is in digital format, but local terrestrial broadcast may enter the distributed network through a separate analog feed.

Analog content needs to be encoded 308 prior to being stored or transmitted. Typically this is done with MPEG2 encoders, although various other encoders are known in the art (MPEG4, wavelet, etc.). In some applications, this content will also be encrypted prior to persistent storage on the disk storage device 110.

The media server 108 described here also contains a broadband interface for receiving digital content such as TCP/IP or UDP/IP packets. This is typically through a cable modem 300 or xDSL link, but many other technologies are known in the art. This link provides data for applications running on the media server 108 or elsewhere on the distributed network. It also provides shared internet connectivity for PCs linked to the network. Digital video may also be received in the distributed network encoded in MPEG2 or some other format. Digital telephony may also be received in the distributed network as in Voice over IP or packet cable.

In one embodiment of the invention, the media server 108 is capable of running representative applications 310, 312. These applications 310, 312 can render graphics either locally on a connected television or remotely on client devices attached to a television. The applications 310, 312 can also render graphics suitable for other client devices such as PCs, PDAs and webpads. In one embodiment of the invention, these graphics are rendered using X-windows calls across the distributed network. In another embodiment, a remote frame buffer protocol such as VNC is used. In another embodiment, HTML is used for rendering. Other methods are known in the art. In yet another configuration of the distributed network, the client devices are capable of running their own applications 328.

As noted above, the centralized resource manager 12 provides centralized control over user requests for media, computing and communication services. In the embodiments described above, the centralized resource manager 12 is depicted as part of the media server. In other configurations, the resource manager 12 can exist on any client device of the distributed network. It is only necessary that client and/or atomic devices wishing to use network resources be able to communicate with the centralized resource manager 12 via the distributed network. This can be done using sockets or other methods known in the art.

Client Devices: Video client devices 112, 114 typically provide a video decoder 320, a frame buffer 322, alpha blending 324 and encoding 326 for analog output as exemplarily illustrated in FIG. 8. These client devices receive video content via the distributed network, and graphics content via the distributed network. The video content is decrypted (as needed) and decoded before being alpha blended with the graphics content. The graphics content provides a GUI. The video client devices 112, 114 also typically provide audio support to decode the audio content accompanying the video content and outputting it to a television or other audio capable output device (e.g., speakers). Video client devices 112, 114 also receive input, typically from IR-remotes or keyboards 340, but other technologies may be used.

In one embodiment, the media server 108 provides the services of a single video client device. This allows a television to be directly connected to the media server. In another configuration, the media server 018 is placed in a closet or basement, and only client devices embodying a video-display capability can display video.

In another configuration, video client devices capable of encoding video as well as decoding video are part of the distributed network. These devices are capable of tuning into digital and/or analog content and encoding the video and directing this video either back to the media server, or directly to the local decoder. This configuration allows the number of tuners to be incremented as video client devices are added to the distributed network.

NAS and Other Storage: In some distributed networks, network attached storage will also be used. In this configuration, one or more disk storage devices may reside on the distributed network. These disk storage devices are capable of receiving content from any source or streaming content to any sync. This content includes audio, video, still images and other data.

Wireless and Other Variations: In some homes there may be more than one type of distributed network. For example, there may be both wired and wireless aspects to the distributed network. There may also be a LAN and local buses such as IEEE 1394. The centralized resource manager 12 is capable of communicating to any client and/or atomic devices on the various wired and wireless aspects comprising the distributed network.

The centralized resource manager 12 is capable of reserving network resources, e.g., disk space, memory, and network bandwidth, on multiple parts of the distributed network using various methods such as TDMA networks, which are known in the art.

Dedicated applications 310,312 capable of interacting with the centralized resource manager 12 may be used to control the allocation of some network resources, such as network bandwidth. In other cases, 3^{rd} party applications may be running on client devices such as PCs. These client devices may be forced to route their traffic through bandwidth shaping components, such as those described in the patent applications listed above and herein incorporated by reference.

The centralized resource manager 12 is also responsible for detecting what network resources are available on the distributed network, and discovering when new client and/or atomic devices are added to the distributed network. Many protocols supporting this function are known in the art, such as SSDP, which is a component of UPnP. If client and/or atomic devices are removed from the distributed network without notifying the centralized resource manager, the scheduling application or the OS can be adapted to indicate an exception when the media pipeline is broken. The centralized resource manager 12 will then be contacted and the local resources of the removed client and/or atomic devices can also be removed from the network resource pool.

Individual hardware components typically have associated software management components that provide both control and data interfaces. For example, the client video decode resource 326 (see FIG. 8) may embody a hardware MPEG2 decoder and associated buffers. Associated software components provide a data and control interface that supports a digital video streaming data and control protocol (e.g., RTP/RTCP/RTSP). It will be apparent to those skilled in the art that the granularity of this resource management can be adjusted without limiting the present invention.

External Control for Reservation of Network Resources

As noted previously, resources of the distributed network may be requested as the result of either a user action or an agent request. In some systems, the media server or other components may be providing a service through an agreement with a broadband service provider. In some cases, it may be advantageous for the service provider to use the centralized resource manager to reserve or request resources independently of the user. For example, a service provider may wish to reserve a tuner and/or disk space at a certain time to push special media content, advertisement, or software upgrade data. In this case, an agent process residing on an Operations Support System at the service provider Network Operations Center (NOC) will generate reservation requests and communicate such requests to the centralized resource manager using a protocol such as the Simple Network Management Protocol (SMNP) over a WAN interface. Other means of configuring the home equipment and resources are known in the art.

Current Sensing system for Automatically Reallocating Network Resources

As noted previously, one constraint of the distributed network described above is that the centralized resource manager does not know when a particular TV is turned off or on. If this information is not known, the centralized resource manager may assign resources such as television tuners used in a media pipeline or session to deliver video to a television that has been shut off. One solution proposed above is to allow the user to turn the client device (and/or media server) into a standby mode. The resources associated with the client device (or media server) would still function if useable by the rest of the distributed network, but specific resources dedicated to that TV would be powered down. One problem with this approach is that many users do not turn off entertainment components, as they do with television sets.

By adding a current sensing system to any client device (and/or media server) having a television set associated therewith, and configuring the client device such that the television is operatively integrated with the current sensing system, which in turn was plugged into a wall outlet, the current sensing system provides indications as to when the TV is in an ON state and when it is in an OFF state. This current sensing system could be contained in the client device (or media server), or it could be contained in an external transformer power supply, or it could be a sensor that wraps around the television cord.

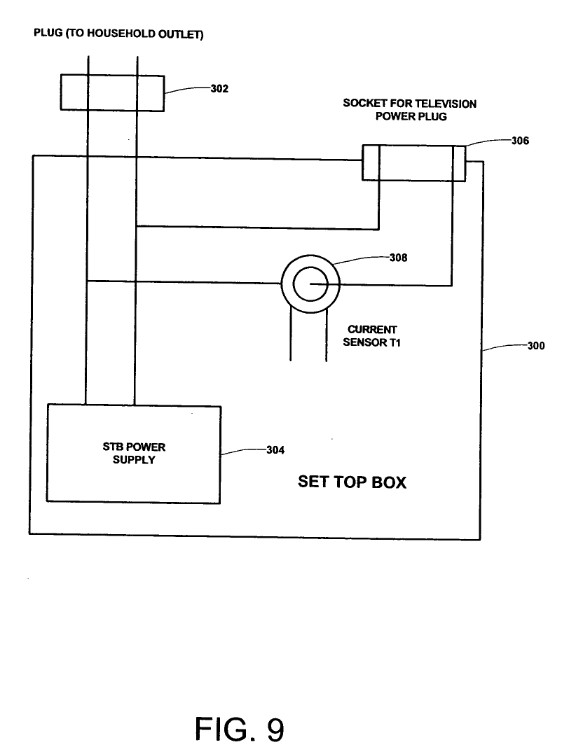

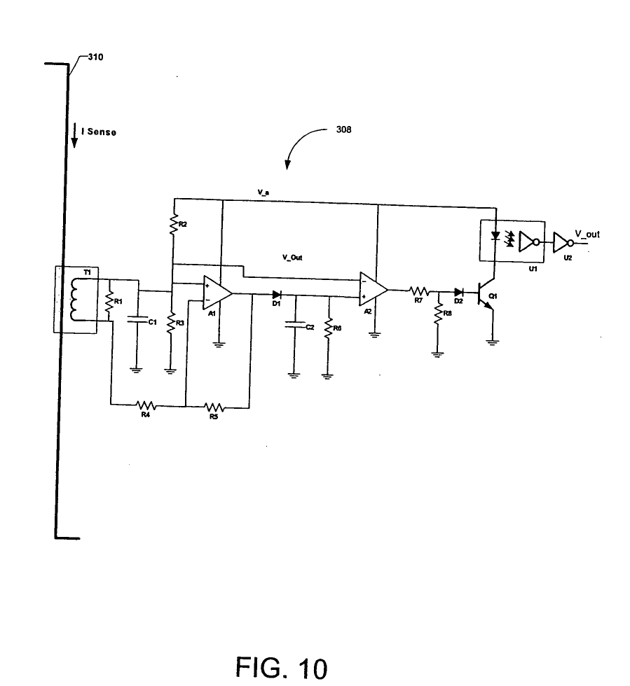

FIGS. 9 and 10 show the design and implementation of one embodiment of a current sensing system 108 according to the present invention, which can perform the functionality described above. Other circuits for current sensing systems are known in the art. Thus, one can combine such a current sensing system with the centralized resource manager and use the data from the current sensing system to determine the reallocation of network resources. Adding this current sensing system to other resource management schemes, such as HAVi, would also be an improvement over conventional systems.

Referring now to FIG. 9, this aspect of the invention is a current sensing system 308 that can be used in an STB 300 or similar client device to detect the ON and OFF states of the television to which the STB 300 is connected. The STB 300 is connected to the AC power (in the United States, typically 110 volts AC) by means of a standard power cord plug 302. The STB 300 includes a power supply 304. A connection is made from this power source to an outlet 306 on the STB 300 to which the television power cord is connected. Thus, the television will draw its current through this connection in the STB 300. One of the power conductors going to the outlet is passed through the current sensing system 308, allowing the circuit shown in FIG. 9 to sense the current and thus determine whether the television is in the ON or OFF state. In FIG. 9, the STB 300 power cord 302 plugs into an AC current outlet in the wall. The television power cord plugs into the outlet 306 furnished on the STB 300. The current sensing system 308 includes a current sense transformer T1 that is inserted in the path of the current that would be drawn by the television. The transformer T1 allows the current drawn by the television to be sensed by a circuit connected to it. This gives an indication to the STB controller as to the state of the television, whether in the ON or OFF state. For purposes of clarity, the ground wires are not shown in FIG. 9.

FIG. 10 shows an implementation of the current sensing system 308. The heavy wire 310 is the AC power connection whose current is being sensed. Typically, this wire will pass through the center of a toroid forming transformer T1 with a one-turn primary and a secondary of about 300 turns. The transformer T1 outputs about 10 mV per 1 Amp of current. Since the output of the transformer T1 is so low, an amplifier is used to boost the signal so that an accurate threshold can be set.

A resistance R1 is the load resistor for the secondary of the transformerT1. Operational amplifier A1 amplifies the voltage across T1 by a ratio of R5/R4. This ratio is chosen to exceed the turn-on voltage of diode D1, allowing the peak detection circuit formed by capacitor C2 and resistor R6 to charge. Operational amplifier A2 serves as a comparator driving current through the voltage divider formed by resistors R7 and R8, which are chosen to set a voltage at the anode of diode D2 to turn on transistor Q1. Transistor Q1 drives the opto-isolator circuit U1 producing a digital output logic low signal. An additional inverter U2 is provided to create a digital signal at V_out which is logically high when current is sensed on 310 (television in the ON state) and logically low when no current is sensed (television in the OFF state).

Referring to FIG. 10, the signal V_Out from the device U2 can be sampled by a computer or embedded controller. Having this current sensing system 308 in the STB 300 enables the computer or embedded controller to exercise discretion with regard to several functions that should not be implemented when the television is in ON state. For example, the software or firmware in the STB 300 can be upgraded when the television is in the OFF state, instead of at an arbitrary time of day. This would ensure that the user will not be inconvenienced by such an upgrade event.

IR Sensing system for Prioritizing Resource Reallocation

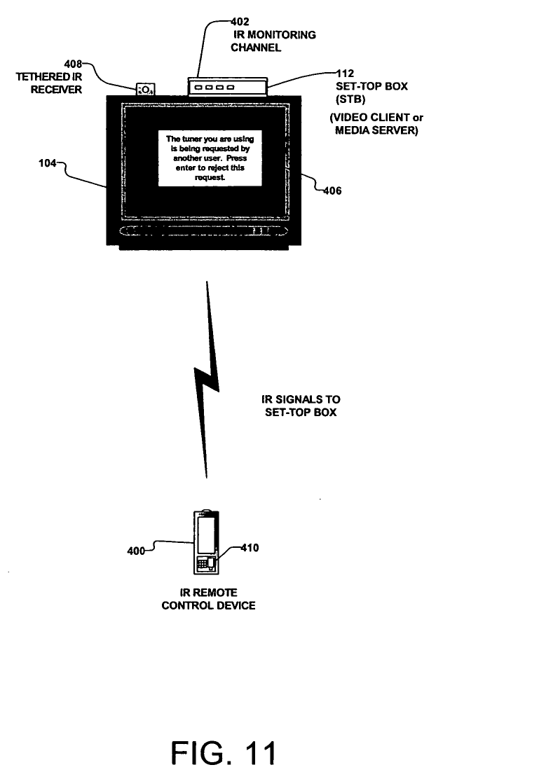

Turning now to FIGS. 11 through 14, another embodiment of a sensing system is shown, which detects signals from a typical remote control unit 400 (conventionally IR signals although RF signals can be used) to determine whether resources 404 associated with a client device 112 (or media server 108) may be automatically reallocated. Note that the resources 404 associated with client device 112 (or media server 108) may be physically located at various locations across the distributed network.

In a system that lacks a current sensing system of the type described above, a need exists to make an educated guess as to whether a particular television or other resource is in use. One means for making this guess is based on examining the signal (IR typically) detector/receiver in the room where the particular television or other resource resides.

For example, if a viewer of one television is requesting a tuner, and if all tuners are in use, and if more than one tuner is in use in a media pipeline to a television set, the ideal solution is to reallocate a tuner 404 that is used by a television 104 that is actually turned off. The centralized resource manager 12 will guess which television is most likely turned off and issue an alert to that screen.

One possible alert is a graphical pop-up window 406 (see FIG. 11), which can signal as follows: “The tuner you are using is being requested by another viewer. Press enter to reject this request.” If a user is watching this television 104 (a viewing session), he/she can be given a certain amount of time to reject the request. If after, say, one minute, there is no response, the centralized resource manager 12 will reallocate that tuner 404.

The drawback to this scheme is that many users would prefer not to see alerts 406 popping up on their screens. By making a considered determination as to which televisions are not in use, the centralized resource manager 12 can first start by alerting a screen that has a high probability of being turned off. If that screen is in use, the central resource manager 12 will then try to reallocate the resources associated with the next-most likely powered down screen.

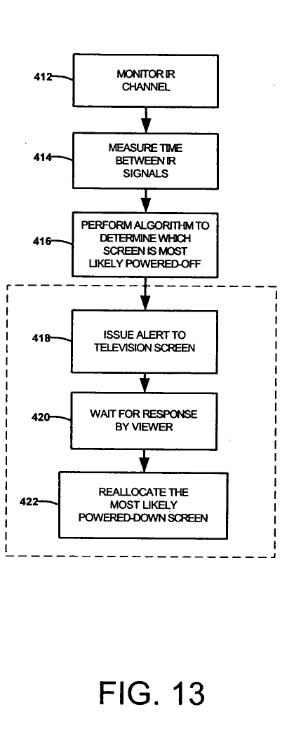

The centralized resource manager 12 can make a considered determination as to the likelihood a screen of television 104 is being watched by monitoring the IR channel 402 (detector/receiver) of the associated client device 112 (or media server 108), one method for reaching such a considered determination being shown in FIG. 13. The IR channel 402 is monitored in a first step 412. The time between received IR signals is measured at step 414. If there has been recent IR activity in the vicinity of the TV 104, there is a high probability that a user is watching and interacting with the TV 104. Conversely, if there has been no IR activity for several hours, there is a high probability that nobody is watching the television 104. An algorithm based on time-between-signals will determine whether the screen of the television 104 is most likely powered off at step 416. Only when a determination has been made at this step 416 that the television 104 is in the OFF state will an alert be issued in step 418 to the screen of the television 104, a response waited for (for a predetermined period of time) in step 420, followed by reallocation in step 422 of the resources 404 associated with the television 104 if no response is received.

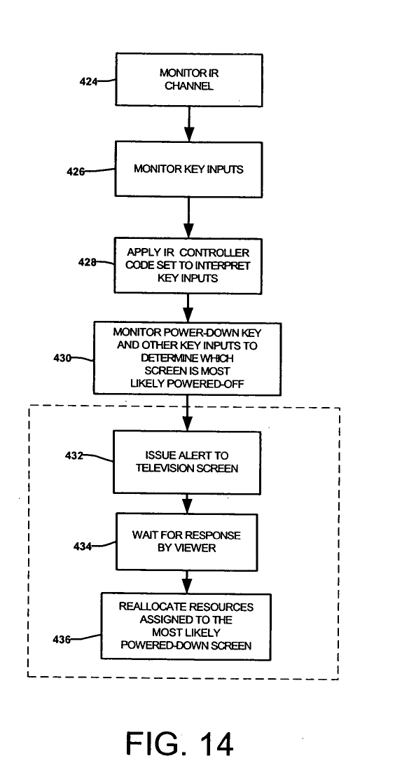

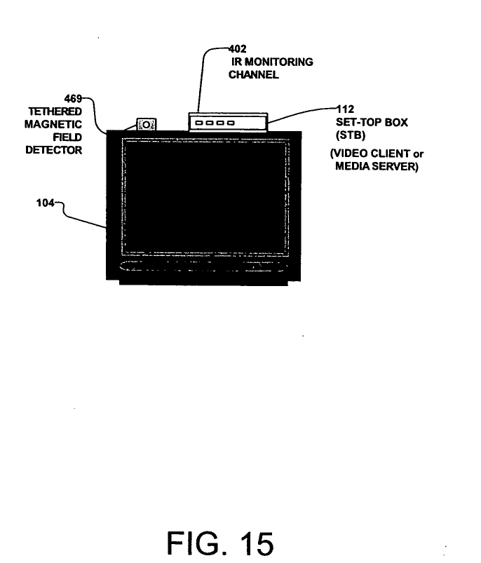

More advanced techniques can be employed, as shown in FIG. 14, such as monitoring the actual key inputs transmitted by the IR remote control device 400. For example, if there has been recent activity, but the most recent IR signal is from a power down key 410 for that TV 104, there is a greater chance that the local TV 104 is off. (The chances of this are in fact greater than if a television IR control 400 has experienced no activity for an hour or so, since the viewer may be engrossed in a program and not interacting with the session). Operational aberrations militate against using the on/off signal to the TV 104 as the exclusive technique for determining whether the TV 104 is in the ON or OFF state.

For example, the IR monitoring channel 402 could detect the IR “On” signal at the same time the TV 104 does. But the IR signal to the IR monitoring channel 402 could be blocked when the TV 104 is turned off. The IR detection circuit within the channel 402 would then be out of sync. This is why other key presses in combination with the On/Off signal are useful. This method is shown in FIG. 14.

In one embodiment of this invention, the sensor of the IR monitoring channel 402 is the same one used to receive signals targeted at the client device 112 (or media server 108). In an alternative embodiment, a physically separate, tethered receiver 408 can be employed as the IR signal sensor.

In another embodiment of this invention, there is included a means for learning the On and Off codes (or common On/Off code) of the remote control unit (secondary) used for the television. It may be preferable that such a means be operative to learn the complete code set for the television. One method is to allow the user to enter the model number or an ID cross-referencing the model number of the TV into such means. Another method is to put the means in learn mode and to press the key to be learned. In the method depicted in FIG. 15, the key inputs are monitored in a step 426, the code set for that particular IR remote control 400 is applied at step 428 to correlate the key inputs with the IR control signals generated by the IR remote control unit 400, and the power down key and other key inputs are monitored to determine which television screen is most likely powered off at a step 430. A screen alert is then issued at step 432, a response waited for in step 434, followed by reallocation of the resource 404 in a step 436 if no response to the screen alert is received.

Note that this method would also be applicable to systems such as HAVi. For example, if a service were negotiating whether or not to steal resources, one method for determining which resource to target would be based on usage of this information.

Electro-Magnetic Field (EMF) Sensing for Prioritizing Resource Reallocation

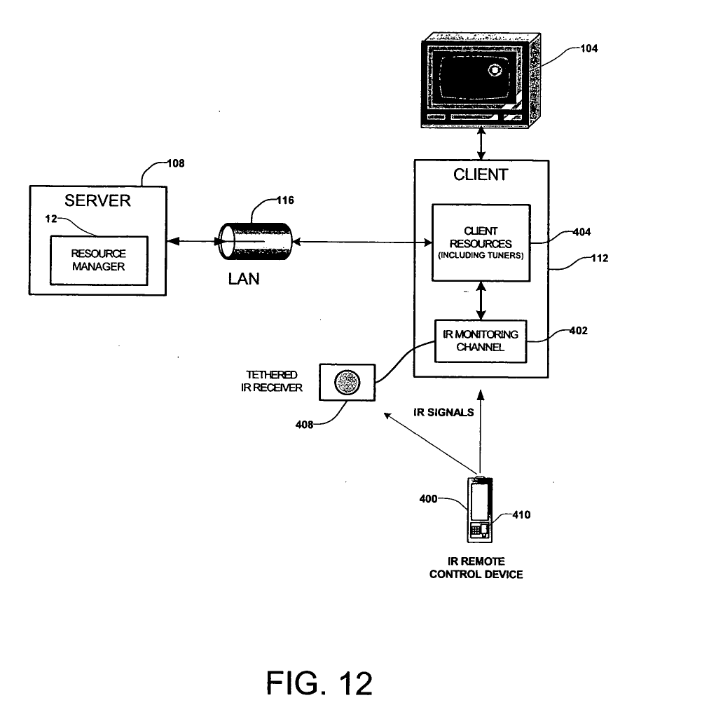

Turning now to FIGS. 15 through 17, another sensing embodiment is shown, which detects the electromagnetic filed (EMF) emitted from a television 104 to determine whether resources 404 (see FIG. 12) associated with a client device 112 (or media server 108) may be automatically reallocated. Note that the resources 404 associated with the client device 112 (or media server 108) may be physically located at various locations across the network.

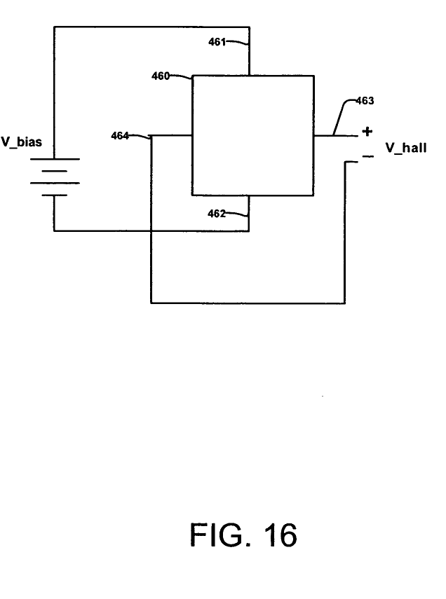

In a system that lacks the current sensing or IR sensing systems described above, a need exists to determine when resources associated with a particular television may be reallocated. Another system for making this determination is based on detecting EMF in the proximity of the particular television 104. This EMF sensing system 469 may be either tethered, as shown in FIG. 16, or physically attached to the client device 112 (or media server 108).

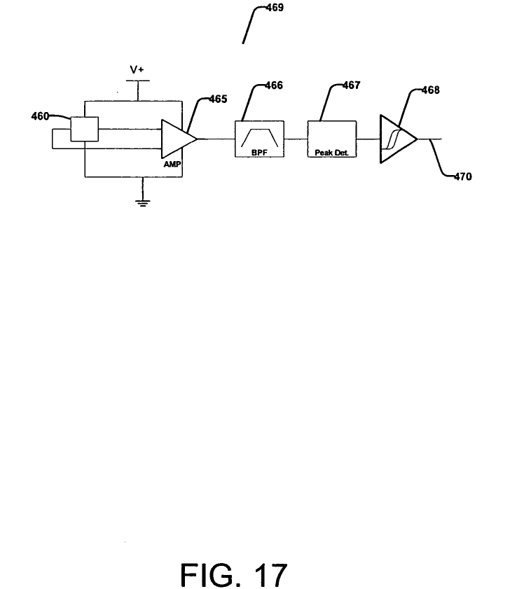

FIGS. 16 and 17 show the design and implementation of one embodiment of the EMF sensing system 469 according to the present invention, which performs the functionality described above. Other circuits for detecting EMF are known in the art. Thus, one can combine such an EMF sensing system 469 with the centralized resource manager and use data (ON or OFF state) from the EMF sensing system 469 to automatically reallocate network resources as applicable. Adding this EMF sensing system to other resource management schemes, such as HAVi, would also be an improvement over conventional systems.

FIG. 16 illustrates how a small sheet of semiconductor material 460 may be wired to construct a basic “Hall-Effect” sensor that is operative (as the sensing element of the EMF sensing system 469) to detect EMF emitted by the television 104 (see FIG. 15). A constant voltage source (V_bias) is placed across the sheet 460 creating a constant bias current from 461 to 462. An output voltage (V_hall) can be measured across the width of the sheet 463, 464. In the absence of a magnetic field, the voltage measured is negligible. In the presence of a magnetic field with flux lines perpendicular to the semiconductor sheet 460, the voltage across the sheet 463, 464 will be directly proportional to the strength of the magnetic field. Magnetic field sensors based on the Hall Effect are commonly available from a number of semiconductor companies including Allegro Microsystems, Analog Devices and Micronas.

Referring now to FIG. 17, the Hall-Effect sensor 460 is placed in the EMF sensing circuit 469. A typical Hall-Effect device provides a small output voltage which is amplified by amplifier 465. Band-pass filter 466 eliminates frequencies other than the primary frequency of the EMF emitted from the television set 104 based on the frame rate (59.94 Hz in the U.S.). A peak detect circuit 467 followed by a hysteresis circuit 468 provides a stable output signal 470. The threshold level of the hysteresis circuit 468 is set above the level expected in the presence of ambient EMF in the home, but well below the level expected with the circuit in situ with an operating television set. If a Schmidtt-trigger circuit is used as the final stage of the hysteresis circuit 468, output provided by the EMF sensing system 469 is a digital signal 470.

Referring now to FIGS. 15 and 17, the output of the EMF sensing circuit 469 can be sampled by a computer or embedded controller. Having this system in the STB 112 enables the system to exercise discretion with regard to several functions that should not be implemented when the television is in the ON state. For example, the software or firmware in the STB 112 can be upgraded when the television is off, instead of at an arbitrary time of day. This would ensure that the user will not be inconvenienced by such an upgrade event.

Power Switching for Automatic Resource Reallocation

Another method of determining when resources assigned to a particular TV session may be automatically reassigned is to provide a means for the user to control the power of the TV through interaction with the STB. In this embodiment the user will use a standard IR (or RF) remote control unit to signal to the STB to turn the TV on or off. By adding a power switch mechanism to the client device (or media server) the STB will then be able to add or remove power to the TV and control when it is in the ON or OFF state. With this added mechanism of control, the centralized resource manager can then determine the ON or OFF state of the television by an internal query to determine the position or state of the power switch 307. The power switch according to the present invention could be contained in the client device (or media server), or it could be contained in an external transformer power supply.

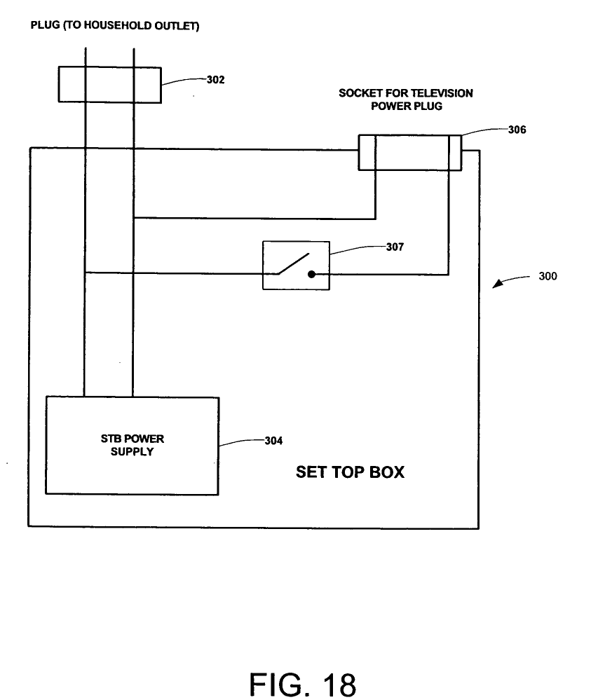

FIG. 18 shows the design and implementation of a power switch according to the present invention, which can perform the functionality described above. Other circuits for switching power are known in the art. Thus, one can combine such a power switch with the centralized resource manager and use the state or position of the power switch to determine the reallocation of network resources. Adding this switching mechanism to other resource management schemes, such as HAVi, would also be an improvement over conventional systems.

Referring now to FIG. 18, this aspect of the invention is a power switch 307 that can be used in an STB 300 or similar client device to control the turning on and turning off of the television which powered through the STB 300. The STB 300 is connected to the AC power (in the United States, typically 110 volts AC) by means of a standard power cord plug 302. The STB 300 includes a power supply 304. A connection is made from this power source 304 to an outlet 306 on the STB 300 to which the television power cord is connected. Thus, the television will draw its current through this connection in the STB 300. One of the power conductors going to the outlet is passed through a power switch 307, allowing the circuit shown in FIG. 18 to control the voltage and thus control whether the television is in the ON or OFF state.

Referring to FIG. 18, the ‘state’ of the power switch 307 can be controlled by and sampled by a computer or embedded controller which is capable of communicating with the centralized resource manager. Thus, the centralized resource manager can effectively control the allocation of the resources of the television after determining whether the television is in the ON or OFF state via a ‘state’ query directed the power switch 307.

These various embodiments and variations come within the scope of the present invention. The embodiments described in detail herein are exemplary of all possible embodiments that practice the spirit of the present invention. The discussion of these embodiments should not be construed as limiting the scope of the appended claims, and it is to be understood that the above description is illustrative rather than limiting.

What is claimed is:

1. In a distributed network including (1) at least one client device operable to communicate with the network and a set of resources useable thereby for processing media content, (2) a media server operable to communicate with the network and operable to receive and fulfill requests for media content to the at least one client device, and a set of resources useable thereby, and (3) a storage element, operable to receive media content from, and provide media content to, the media server, and a set of resources useable thereby to store media content, the sets of resources useable by the storage element, the media server and the at least one client device defining a set of network resources, the improvement comprising:
a centralized resource manager operable to communicate with the distributed network and to respond to a request for utilization of the network resources by allocating the network resources to define all or part of a pipeline to fulfill the request.

2. In the distributed network of claim 1 the further improvement wherein:
within the distributed network, at least one of the storage element, the media server and the at least one client device has a local resource manager associated therewith;
the centralized resource manager is operable to exercise control over the local resource manager associated with any of the storage element, the media server, and the at least one client device; and
the centralized resource manager responds to the request by dynamically identifying network resources available to fulfill the request, and, if network resources are identified as available to fulfill the request, assigning specific network resources from the available network resources to define all or part of the pipeline to fulfill the request, and reserving the assigned network resources defining all or part of the pipeline to fulfill the request.

3. In the distributed network of claim 2 the further improvement wherein the centralized resource manager is operable, if network resources are not available to fulfill the request, to provide a signal that network resources are not available to fulfill the request.

4. In the distributed network of claim 2 the further improvement wherein the centralized resource manager is operable, once the reserved network resources defining all or part of the pipeline have been used to fulfill the request, to reallocate the reserved network resources that previously defined all or part of the pipeline as available network resources.

5. In the distributed network of claim 2 the further improvement wherein the request is from an agent and wherein
the centralized resource manager is further operative to respond to the agent request for utilization of network resources by dynamically identifying network resources available to fulfill the agent request, and, if network resources are identified as available to fulfill the agent request, assigning specific network resources from the available network resources to define all or part of the pipeline to fulfill the agent request, and reserving the assigned network resources defining all or part of the pipeline to fulfill the agent request.

6. In the distributed network of claim 2 the further improvement wherein the request is from an agent and wherein
the centralized resource manager is further operative to respond to and process the agent request for utilization of network resources by dynamically identifying network resources available to fulfill the agent request, and, if network resources are identified as available to fulfill the agent request, identifying the available network resources to the agent so that the agent can configure and control specific network resources from the available network resources to define all or part of the pipeline to fulfill the agent request.

7. In the distributed network of claim 2 the further improvement wherein the centralized resource manager is operative to reserve the assigned network resources defining the pipeline to fulfill the request for a scheduled time and duration in the future.

8. In the distributed network of claim 2 the further improvement wherein the centralized resource manager is operable to detect addition of a new client device having a set of resources useable thereby to the network, and to add the set of resources useable by the new client device to the network resources.

9. In the distributed network of claim 2 the further improvement wherein the centralized resource manager is operable to detect the disconnection of an existing client device, having a set of resources associated therewith, from the network, and to remove the set of resources of the disconnected client device from the network resources.

10. In the distributed network of claim 2 the further improvement wherein:
the centralized resource manager is interfaced with an atomic device having a set of resources associated therewith but not having a local resource manager associated therewith; and
the centralized resource manager is operable to control the set of resources associated with the atomic device through proxy reservation, wherein any resource of the set of resources associated with the atomic device may be identified, assigned, and reserved to fulfill the media processing service request.

11. In the distributed network of claim 10 the further improvement wherein the atomic device is a television.

12. In the distributed network of claim 10 the further improvement wherein the atomic device is a Set-Top Box.

13. In the distributed network of claim 2 3, 5, or 6 the further improvement wherein:
the request is a request to record media content in the storage element; and wherein
the centralized resource manager is operable to determine whether the storage element has sufficient storage capacity associated therewith to record the media content.

14. In the distributed network of claim 13 the further improvement wherein the centralized resource manager is operable, in response to a determination that the storage element does not have sufficient storage capacity associated therewith to record the media content, to delete files from the storage element.

15. In the distributed network of claim 13 the further improvement wherein the centralized resource manager is operable, in response to a determination that the storage element does not have sufficient storage capacity associated therewith to record the media content, to provide a signal indicative thereof.

16. In the distributed network of claim 13 the further improvement wherein the at least one client device comprises a plurality of client devices operable to communicate with the distributed network, each of the plurality of client devices including a set of resources including a local resource manager, accessible through the distributed network, for processing media content.

17. A distributed network, comprising:
a plurality of client devices operable to communicate with a server via a distributed topology and a network protocol, each of the plurality of client devices having a set of resources including a local resource manager accessible through the network, for processing media content;
a media server, operable to communicate with the plurality of client devices via the network, and having a set of resources including a local resource manager accessible through the network, for receiving media content from at least one content provider and for processing media content;
a storage element, operable to communicate with the network and to store digital content, and having a set of resources including a local resource manager accessible through the network; and wherein:
the sets of resources associated respectively with the plurality of client devices, the media server, the storage element, and otherwise with the network collectively define network resources;
the network resources include at least one presentation device for presenting media content to a user; and
a centralized resource manager operable to communicate with the network and to respond to a request for utilization of the network resources by detecting network resources available to fulfill the request, assigning specific network resources to define all or part of a pipeline that fulfills the request, and reserving the assigned network resources defining the pipeline to fulfill the request.

17. A distributed network, comprising:
a plurality of client devices operable to communicate with a server via a distributed topology and a network protocol, each of the plurality of client devices having a set of resources including a local resource manager accessible through the network, for processing media content;
a media server, operable to communicate with the plurality of client devices via the network, and having a set of resources including a local resource manager accessible through the network, for receiving media content from at least one content provider and for processing media content;
the media server being further operative to communicate with an agent process at the at least one content provider via a wide area network;
a storage element, operable to communicate with the network and to store media content, and having a set of resources including a local resource manager accessible through the network; and wherein:
the sets of resources associated respectively with the plurality of client devices, the media server, the storage element, and otherwise with the network collectively define network resources;
the network resources include at least one presentation device for presenting media content to a user; and
a centralized resource manager operable to communicate with the network and to respond to a request from the agent process to utilize the network resources by detecting network resources available to fulfill the request from the agent process, assigning specific network resources to define all or part of a pipeline that fulfills the request of the agent process, and reserving the assigned network resources defining the pipeline to fulfill the request of the agent process.

19. A distributed network, comprising:
at least one client device, operable to communicate with the network and having a set of resources including a local resource manager accessible through the network, for processing media content;
at least one atomic device, interfaced with the network and having a set of resources accessible through the network, for processing media content;
a media server, operable to communicate with the network and having a set of resources including a local resource manager accessible through the network, for receiving digital content from at least one content provider and for processing digital content;
a storage element operable to communicate with the network and to store media content, and having a set of resources including a local resource manager accessible through the network; and wherein
the at least one client device, the at least one atomic device, the media server, and the storage element are operable to communicate with each other via the network;
the sets of resources associated respectively with the at least one client device, the at least one atomic device, the media server, the storage element, and any resources associated with the network collectively define network resources; and
a centralized resource manager operable to communicate with the network and to respond to a request for utilization of the network resources to detect network resources available to fulfill the request, to assign specific network resources to define all or part of a pipeline that fulfills the request and to reserve the assigned network resources defining the pipeline to fulfill the user request.

20. The distributed network of claim 19 wherein the network resources include at least one presentation element operable to present media content to a user.

21. The distributed network of claim 20 wherein the at least one presenting element is a resource of the set of resources associated with the media server.
